(19) United States
(12) Patent Application Publication
(10) Pub. No.: US 2007/0011243 A1
(43) Pub. Date: Jan. 11, 2007

(54) System and method for storing and transmitting a file data using internet messenger

(76) Inventor: Seung-Tae Kim, Seoul (KR)

Correspondence Address: Wilson & Ham;PMB 348, 2530 Berryessa Road, San Jose, CA, 95132, US

(21) Appl. No.: 10/557,856

(22) PCT Filed: May 19, 2004
(86) PCT No.: PCT/KR04/01178

§ 371 Date: Nov. 21, 2005

(30) Foreign Application Priority Data
May 23, 2003 (KR) 10-2003-0032786

(51) Int. Cl. G06F 15/16

(52) U.S. Cl. 709/206

(57) ABSTRACT

The present invention has its purpose to provide a system and method for storing and transmitting a file using an Internet messenger, wherein a file of a messenger user is stored in a messenger function-performing file storage unit, which is separately connected to a messenger server, or the file storage unit is used as a relay point where a file is transferred between the messenger users, by utilizing P2P transfer technology of a conventional messenger system without additional log-on or installation of an additional program. To accomplish this object, the present invention provides a messenger system for storing and transferring a file using an Internet messenger which includes a messenger server and a plurality of messenger clients connected to the messenger server for exchanging a message or file with the messenger server. The messenger system of the present invention comprises a messenger function-performing file storage unit connected to the messenger server. Further, the messenger function-performing file storage unit comprises a messenger function-performing unit for receiving a file, which will be transferred from a user of a messenger client serving as a sender to a user of a messenger client serving as a recipient among the plurality of the messenger clients, and transmitting the received file to the user of the messenger client serving as the recipient; a file storage unit for storing the file received through the messenger function-performing unit therein; and a control unit for controlling storing the file received through the messenger function-performing unit in the file storage unit and transferring the file stored in the file storage unit to a user of a messenger client serving as a recipient when the user of the messenger client serving as the recipient accepts the receipt of the file.

### TECHNICAL FIELD

The present invention relates to technology for storing and transferring files using a n Internet messenger. More particularly, the present invention relates to a system for storing and transferring files using an Internet messenger wherein the storage of files by a messenger user and the transfer of files among messenger users can be easily made through a file storage unit for performing a messenger function, which is separately connected to a messenger server.

### BACKGROUND ART

Internet messenger services, which are one of a variety of services provided by the Internet that has become a part of daily life, allow users, who access messenger servers, to exchange short messages or files in real time, unlike e-mail services.

In the above, messages are transferred among messenger users through a messenger server. Each of the messenger users can receive a message from other users through the messenger server while accessing the messenger server and also transmit messages to other users through the messenger server.

However, in case of transferring files, significantly greater capacity is needed compared to transferring messages. If a file is transferred via a messenger server like a message, it leads to excessive overload in the server. Furthermore, unlike messages, a file is transferred in a one to one relationship. Therefore, as shown in FIG. 1, a file is transferred using the P2P method which is a peer-to-peer file exchange method without passing through a messenger server 11.

The process of exchanging files among messenger users using the P2P method in a conventional messenger system shown in FIG. 1 will now be briefly described.

Referring to FIG. 2, while a conventional messenger system 1 operates normally (S21), the messenger server 11 determines whether a file can be transferred to messenger client 2 13 according to a request from a user of messenger client 1 12 (S22).

If it is determined that the transfer of a file is possible, the file is successfully transferred from the user of messenger client 1 12 to messenger client 2 13 (S23). Meanwhile, if the transfer of a file is not possible, the transfer of the file from the user of messenger client 1 12 to messenger client 2 13 is unsuccessful (S24).

More specifically, a case where the transfer of a file is possible among messenger clients in a conventional messenger system 1 is shown in FIG. 1. In this case, steps S22 and S23 in which the file is successfully transferred from the user of messenger client 1 12 to the user of messenger client 2 13 are as follows.

\textcircled{1} The user of messenger client 1 12 informs the messenger server 11 of the fact that he or she wants to transfer a file to the user of messenger client 2 13.

\textcircled{2} The messenger server 11 notifies the user of messenger client 2 13 of the fact that the user of messenger client 1 12 tries to transfer the file and asks the user of messenger client 2 13 whether to receive the file.

\textcircled{3} The user of messenger client 2 13 informs the messenger server 11 of the fact that he or she will accept the receipt of the file.

\textcircled{4} The messenger server 11 transfers an IP address as Internet positional information of the user of messenger client 2 13 to the user of messenger client 1 12 so that the user of messenger client 1 12 and the user of messenger client 2 13 can exchange the file in a state where they are directly connected to each other. In this case, it is possible to transfer the Internet IP address of the user of messenger client 1 12 to the user of messenger client 2 13 according to the format that a messenger is implemented.

\textcircled{5} The transfer of the file between the user of messenger client 1 12 and the user of messenger client 2 13 is successful through the Internet IP address informed by the messenger server 11 with the users directly connected to each other.

Meanwhile, there is a case where the transfer of a file is impossible between users of the messenger clients in the conventional messenger system 1 shown in FIG. 1. In this case, steps S22 and S24 in which the transfer of a file from the user of messenger client 1 12 to the user of messenger client 213 is unsuccessful will now be described by taking FIGS. 3 to 5 as examples.

First, there is a case where both users of messenger client 1 12 and messenger client 2 13 employ a private Internet network, as shown in FIG. 3.

If messenger client 1 12 or messenger client 2 13 uses a private Internet network rat her than a public Internet network, Internet positional information which is transferred from messenger server 11 to messenger client 1 12 or messenger client 2 13 is the IP address of a private network gateway 121 of messenger client 1 located in a relevant private network or the IP address of a private network gateway 131 of messenger client 2 located in a private network. Thus, access is not made between the users of messenger client 1 12 and messenger client 2 13. Accordingly, the file transfer file fails.

If messenger client 1 12 or 2 13 employs a private Internet network, a conventional messenger system 1 causes the file transfer direction to be reverse for the purpose of the successful transfer of a file. In other words, whoever is the file sender, a user of the private Internet network accesses a user of the public Internet network and transfers the file.

If both users of messenger clients 1 12 and 2 13 employ a private Internet network, however, it is impossible to get a correct IP address of a counterpart user although one user tries to transfer a file. The transfer of the file is thus unsuccessful.

Such a case where both users of messenger client 1 12 and messenger client 2 13 employ a private Internet network will now be described. The same portions as steps (\textcircled{1} to \textcircled{3}) in the example that explains the case where the transfer of the file is successful will not be described.

\textcircled{4} The messenger server 11 can transfer an IP address as Internet positional information on a private network gateway 131 of messenger client 2 located in a private network to the user of messenger client 1 12 or the IP address of a private network gateway 121 of messenger client 1 located in a private network to the user of messenger client 2 13.

\textcircled{5} The user of messenger client 1 12 and the user of messenger client 2 13 are not directly connected to each other, but connected only to the respective private network gate ways 121 and 131. Therefore, the transfer of the file is unsuccessful.

Secondly, as shown in FIG. 4, there is a case where the user of messenger client 1 12 employs a private Internet network and a firewall 132 is installed in messenger client 2 13

Messenger server 11 transmits the IP address of messenger client 2 13 to messenger client 1 12 for the successful transfer of a file. However, the firewall 132 prevents the user of messenger client 1 12 from accessing the user of messenger client 2 13. Thus the transfer of the file fails.

On the contrary, if the user of messenger client 2 13 accesses the user of messenger client 1 12, the user of messenger client 2 13 can access messenger client 1 12 unless the firewall 132 shuts its outgoing port.

Therefore, in case where a firewall 132 is installed, the user of messenger client 2 13 can transfer a file to messenger client 1 12, but not the reverse. Furthermore, even in this case, in the event that messenger client 1 12 is a private Internet network, the transfer of the file is completely impossible and thus fails.

The case where the user of messenger client 1 12 employs a private Internet network and a firewall 132 is installed in messenger client 2 13 will now be described. The same portions as steps (\textcircled{1} to \textcircled{3}) in the example that explains the case where the transfer of a file is successful will not be described.

\textcircled{4} The messenger server 11 transfers an IP address as Internet positional information of messenger client 2 13 to the user of messenger client 1 12.

\textcircled{5} The user of messenger client 1 12 and the user of messenger client 2 13 are not directly connected to each other but are connected only to the private network gateway 121 of messenger client 1 located in a private network, or are blocked by means of a firewall 132 of messenger client 2 13. Therefore, the transfer of the file is unsuccessful.

Thirdly, as shown in FIG. 5, there is a case where the user of messenger client 2 13 is absent.

In the event that a file is transmitted to a user of messenger client 2 13 who is a file recipient using a messenger, it is necessarily required that approval be obtained from a user of messenger client 2 13 who is a file recipient in order to prevent the file from being transferred only with the intention of the user of messenger client 1 12 who is the file sender. Thus, the transfer of the file is actually successful only when the user of messenger client 1 12 who is the file sender requests the transfer of the file and the user of messenger client 2 13 who is the file recipient accepts the receipt of the file.

In the event that the user of messenger client 2 13 who is the file recipient is absent, it is impossible to accept the receipt of a file. The user of messenger client 1 12 has to wait until the user of messenger client 2 13 reaches a state where the user can accept the receipt of the file.

The case where a user of a counterpart messenger client 2 13 is absent will now be described. The same portions as the steps (\textcircled{1} and \textcircled{2}) in the example that explains the case where the transfer of the file is successful will not be described.

\textcircled{3} The user of messenger client 2 13, who is absent, cannot notify the messenger server 11 of the fact that he or she approves the receipt of the file.

\textcircled{4} The messenger server 11 informs the user of messenger client 1 12 of the fact that the user of messenger client 2 13 cannot approve the receipt of the file.

\textcircled{5} Since the user of messenger client 1 12 and the user of messenger client 2 13 are not directly connected to each other, the transfer of the file fails.

It is the same as the above case. That is, as shown in FIG. 6, even though the user of messenger client 2 13 returns to his or her position, if the user of messenger client 1 12 is not still seated, it amounts to a result that the user of messenger client 1 12 for beginning transferring the file is absent. Therefore, the transfer of a file is not accomplished.

That is, even in a case where the users of messenger client 1 12 and messenger client 2 13 are in an on-line state, the transfer of a file will fail if either of two users is absent.

As such, the reason that the file is not directly transferred from the user of messenger client 1 12 to the user of messenger client 2 13 since the transfer of a file between the messenger clients in the conventional messenger system 1 shown in FIG. 1 cannot be made is due to the P2P method in which users of messenger client 1 12 and messenger client 2 13 should solve their own problems by themselves without relying on the messenger server 11 when all the files are transmitted on the messenger system.

A server operator of a conventional messenger system can provide a stabilized service while reducing overload through this P2P method. If users of many messenger clients are blocked by private IP addresses and firewalls as in the prior art, however, there occurs a case where files cannot be transferred.

In addition, a user of a counterpart messenger client must be always present on-line. Thus, a file cannot be transmitted to users of a messenger client who are absent. Due to an operational situation of such a messenger system, it is impossible to store a file of a messenger user.

### DISCLOSURE OF INVENTION

The present invention is conceived to solve the aforementioned problems in the prior art. An object of the present invention is to provide a system and method for storing and transmitting files using an Internet messenger, wherein a file of a messenger user is stored in a messenger function-performing file storage unit, which is separately connected to a messenger server, or the file storage unit is used as a relay point where a file is transferred between the messenger users, by utilizing P2P transfer technology of a conventional messenger system without additional log-on or installation of an additional program.

According to an aspect of the present invention for achieving the object, there is pro vided a messenger system for storing and transferring a file using an Internet messenger, which includes a messenger server and a plurality of messenger clients connected to the mess enger server for exchanging a message or file with the messenger server. The messenger system of the present invention comprises a messenger function-performing file storage unit connected to the messenger server, wherein the messenger function-performing file storage unit includes a messenger function-performing unit for receiving a file, which will be transferred from a user of a messenger client serving as a sender to a user of a messenger client serving as a recipient among the plurality of the messenger clients, and transmitting the received file to the user of the messenger client serving as the recipient; a file storage unit for storing the file received through the messenger function-performing unit therein; and a control unit for controlling storing the file received through the messenger function-performing unit in the file storage unit and transferring the file stored in the file storage unit to a user of a messenger client serving as a recipient when the user of the messenger client serving as the recipient accepts the receipt of the file.

According to another aspect of the present invention, there is provided a messenger system for storing and transferring a file using an Internet messenger, which includes a messenger server and a plurality of messenger clients connected to the messenger server for exchanging a message or file with the messenger server. The messenger system of the present invention comprises a messenger function-performing file storage unit connected to the messenger server, wherein the messenger function-performing file storage unit includes a messenger function-performing unit for receiving a file that a user of any one of the plurality of the messenger clients wishes to store and transmitting the received file to a user of the messenger client; a file storage unit for storing the file received through the messenger function-performing unit therein; and a control unit for controlling storing the file received through the messenger function-performing unit in the file storage unit and transferring the file stored in the file storage unit to a user of the messenger client through the messenger function-performing unit when there is a request from the user of the messenger client.

Preferably, a firewall is installed between the messenger server and the messenger client serving as the sender or between the messenger server and the messenger client serving as the recipient, and a web interface for connecting the messenger client and the messenger function-performing file storage unit through the firewall is further provided between the firewall and the messenger function-performing file storage unit, whereby the user of the messenger client can receive or store the file that is being stored in the file storage unit using a web browser.

The file storage unit may be a storage system provided on the Internet.

More preferably, at least one of the plurality of the messenger clients has a plug-in program installed, and the messenger function-performing file storage unit further comprises a file transmission/reception-executing unit that allows the messenger client having the plug-in program installed in and the messenger function-performing file storage unit to exchange a file directly through the plug-in program.

According to a further aspect of the present invention, there is provided a method for storing/transferring a file in/to a messenger system which includes a messenger server, a plurality of transmission/reception messenger clients connected to the messenger server for exchanging a message or file with the messenger server, and a messenger function-performing file storage unit connected to the messenger server and having a messenger function and a file storage function. The method of the present invention comprises the steps of allowing the messenger function-performing file storage unit to receive a file, which is to be transferred from a user of a messenger client serving as a sender to a user of a messenger client serving as a recipient among the plurality of the messenger clients, through the messenger function and then to store the file therein through the file storage function; and transferring a file stored in the messenger function-performing file storage unit to a user of a messenger client serving as a recipient through the messenger function when the user of the messenger client serving as the recipient accepts the receipt of the file.

According to a still further aspect of the present invention, there is provided a method for storing/transferring a file in/to a messenger system which includes a messenger server, a plurality of transmission/reception messenger clients connected to the messenger server for exchanging a message or file with the messenger server, and a messenger function-per forming file storage unit connected to the messenger server and having a messenger function and a file storage function. The method of the present invention comprises the steps of allowing the messenger function-performing file storage unit to receive a file that will be stored by a user of any one of the plurality of the messenger clients through the messenger function and then to store the file therein through the file storage function; and transferring a file stored in the messenger function-performing file storage unit to a user of a messenger client through the messenger function when there is a request from the user of the messenger client.

### BRIEF DESCRIPTION OF DRAWINGS

The above and other objects, features and advantages of the present invention will become apparent from the following description of preferred embodiments given in conjunction with the accompanying drawings, in which:

FIG. 1 is a block diagram showing a system for transferring files using a conventional Internet messenger;

FIG. 2 is a flowchart illustrating a simplified operating process of the messenger system shown in FIG. 1;

FIGS. 3 to 6 are block diagrams illustrating cases where the transfer of a file is unsuccessful in the operating process of the messenger system shown in FIG. 2;

FIG. 7 is a flowchart illustrating an operating process of a messenger system for storing and transferring a file using an Internet messenger according to an embodiment of the present invention;

FIGS. 8 to 10 and FIG. 15 are block diagrams showing a system for storing and transferring a file using an Internet messenger according to an embodiment of the present invention;

FIGS. 11 to 14 are exemplary screens showing the operating process of the messenger system shown in FIGS. 8 to 10; and

FIG. 16 is an exemplary screen that is shown by the operation of a plug-in program installed in a messenger client in the messenger system shown in FIG. 15.

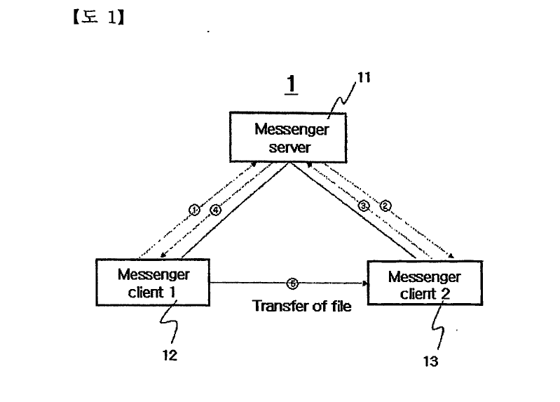

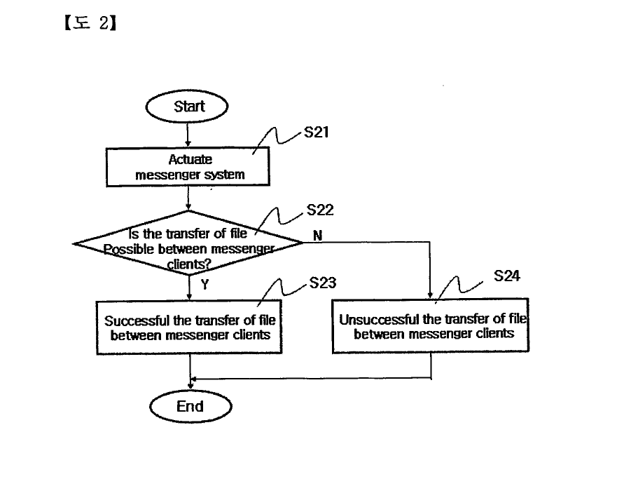

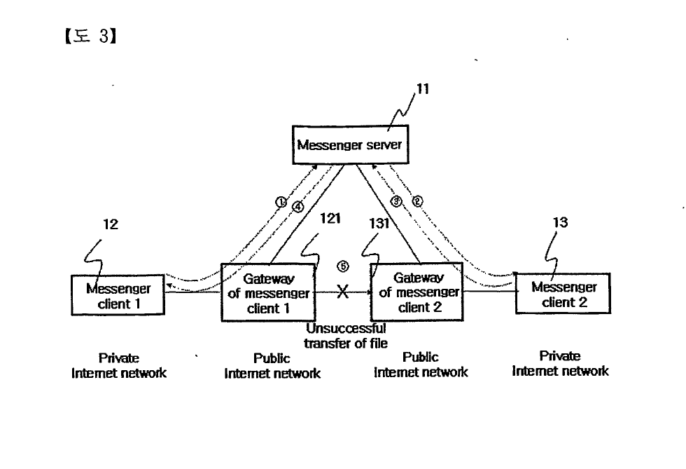

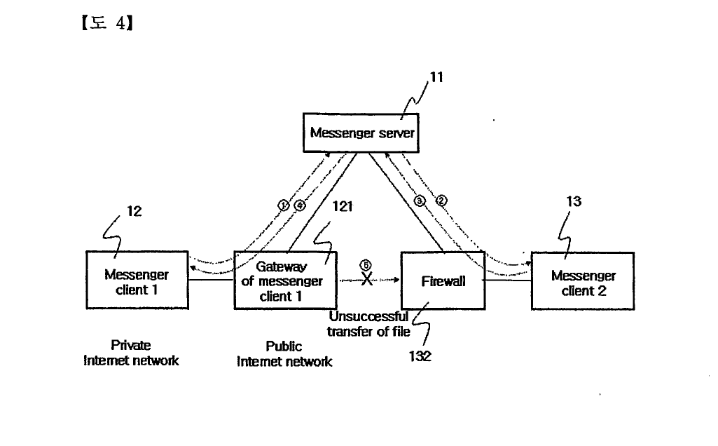

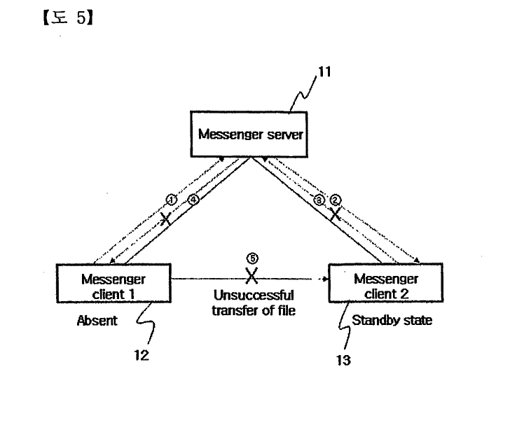

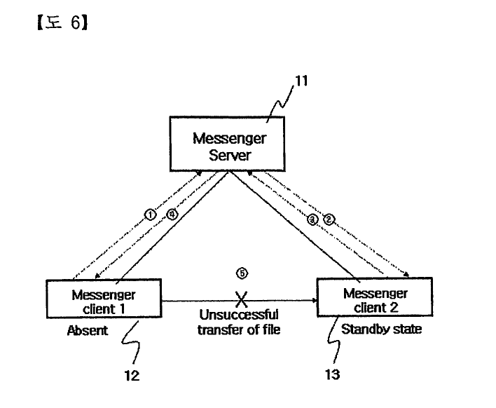

### BEST MODE FOR CARRYING OUT THE INVENTION

Hereinafter, preferred embodiments of the present invention will be described in detail with reference to the accompanying drawings.

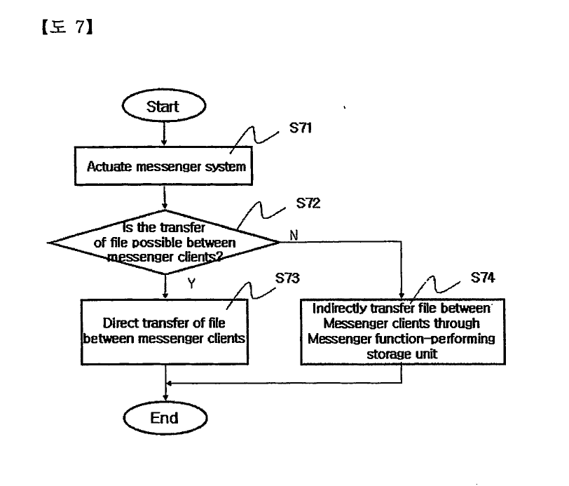

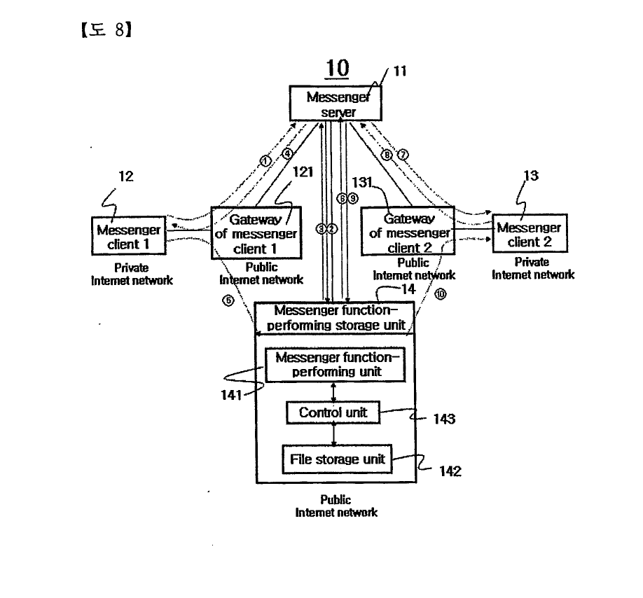

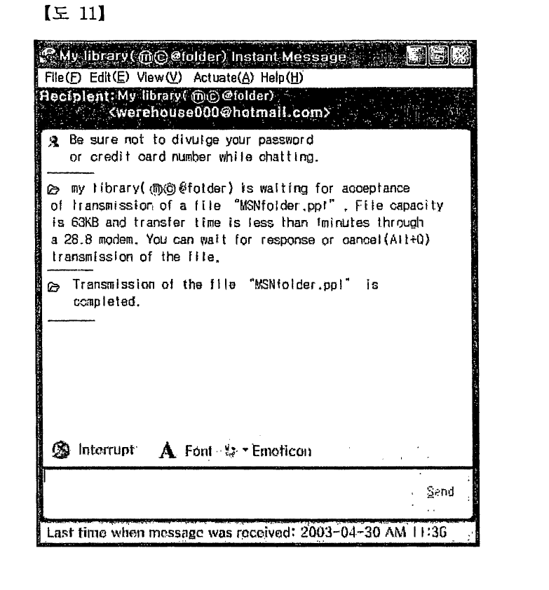

FIG. 7 is a flowchart illustrating the operating process of a messenger system for storing and transferring files using an Internet messenger according to an embodiment of the present invention. FIGS. 8 to 10 and FIG. 15 are block diagrams showing a system for storing and transferring files using an Internet messenger according to an embodiment of the present invention. FIGS. 11 to 14 are exemplary screens showing the operating process of the messenger system shown in FIGS. 8 to 10.

The operating process of the messenger system for storing and transferring files using an Internet messenger according to an embodiment of the present invention will now be briefly described. Referring to FIG. 7, while the messenger system operates normally (S71), a messenger server 11 determines whether a file can be transferred to a messenger client 2 13 according to the request from a user of messenger client 1 12 (S72).

If it is determined that the transfer of the file is possible, the file is transferred directly from the user of messenger client 1 12 to messenger client 2 13 (S73). Meanwhile, if the transfer of a file is impossible, the file is transferred indirectly from the user of messenger client 1 12 to messenger client 2 13 through a messenger function-performing file storage unit, which will be described hereinafter (S74).

In this embodiment, if a file is not transferred directly between users of conventional messenger clients, a case where a file is transferred indirectly between the users through the messenger function-performing file storage unit will be described.

Referring to FIG. 8, a system for storing and transferring files using an Internet mess enger 10 according to an embodiment of the present invention includes a messenger server 11, a messenger client 1 12 connected to the messenger server 11 through a private network gateway 121 and located in a private network, a messenger client 2 13 connected to the messenger server 11 through a private network gateway 131 and located in a private network, and a messenger function-performing file storage unit 14 connected to the messenger server 11 and located in a public network.

The messenger server 11 informs users of messenger clients who previously registered IP addresses as Internet positional information of the users, so that users who access the server 11 using corresponding IP addresses can exchange files directly.

Messenger clients 1 12 and 2 13 access the messenger server 11 so that registered users can exchange files. In an embodiment of the present invention, messenger clients 1 12 and 2 13 located in a private network are connected to the messenger server 11 located in the public Internet network via private network gateways 121 and 131.

In the above, the IP addresses that are transferred to messenger clients 1 12 and 2 13 by the messenger server 11 are IP addresses of the private network gateways 121 and 131 of messenger clients 1 and 2 located in corresponding private networks. Thus, unlike a public Internet network having a unique address over the whole Internet, a private Internet net work having an address that is personally used does not have a unique Internet address. It is thus difficult to know the correct position of a counterpart. Since access is made between the users of messenger clients 1 12 and 2 13 located in private networks, it is impossible to transfer the file.

In order to solve this problem, in the messenger system 10 according to an embodiment of the present invention, the messenger function-performing file storage unit 14 located in the public Internet network is connected to the messenger server 11.

Therefore, the relationship between the user of messenger client 1 12 and the messenger function-performing file storage unit 14 results in a private Internet network versus a public Internet network. The relationship between the user of messenger client 2 13 and the messenger function-performing file storage unit 14 also results in a public Internet network versus a private Internet network. It is thus possible to transfer a file from the user of messenger client 1 12 to the user of messenger client 2 13 through the messenger function-performing file storage unit 14.

The messenger function-performing file storage unit 14 includes a messenger function-performing unit 141, a file storage unit 142 and a control unit 143, in order to transfer a file from messenger client 1 12 to messenger client 2 13 and store a file that will be transfer red from messenger client 1 12 to messenger client 2 13.

If a file is transferred from messenger client 1 12 to messenger client 2 13, the mess enger function-performing unit 141 receives a file from the user of messenger client 1 12 serving as the sender through a messenger function in the private Internet network versus public Internet network relationship and transmits the received file to the user of messenger client 2 13 serving as the recipient through the messenger function in the public Internet network versus private Internet network relationship.

The file storage unit 142 stores the file received from the user of messenger client 1 12 serving as the sender through the messenger function-performing unit 141 therein by means of the file storage function.

The control unit 143 controls the file received through the messenger function-performing unit 141 to be stored through file storage function of the file storage unit 142. Furthermore, if there is acceptance from the user of messenger client 2 13 serving as the recipient, the control unit 143 controls the file that is being stored in the file storage unit 142 to be transferred to the user of messenger client 2 13 serving as the recipient through the messenger function of the messenger function-performing unit 141.

In the messenger system 10 constructed above according to an embodiment of the present invention, the process of transferring the file from messenger client 1 12 to messenger client 2 13 will now be described.

\textcircled{1} The user of messenger client 1 12 informs the messenger server 11 of the fact that he or she wants to transfer a file to the messenger function-performing file storage unit 14.

\textcircled{2} The messenger server 11 notifies the messenger function-performing file storage unit 14 of the fact that the user of messenger client 1 12 tries to send the file and asks the messenger function-performing file storage unit 14 whether to receive the file.

\textcircled{3} The messenger function-performing file storage unit 14 informs the messenger server 11 of the fact that it will accept the receipt of the file.

\textcircled{4} The messenger server 11 transfers an IP address of the messenger function-performing file storage unit 14 located in the public Internet network to the user of messenger client 1 12 located in the private Internet network so that the user of messenger client 1 12 and the messenger function-performing file storage unit 14 can exchange the file in a state where they are directly connected to each other.

\textcircled{5} The user of messenger client 1 12 completes the transfer of the file to the messenger function-performing file storage unit 14 in a state where messenger client 1 12 is connected through the IP address of the messenger function-performing file storage unit 14 informed by the messenger server 14. The fact that the file will be transferred to the user of messenger client 2 13 is transferred from the user of messenger client 1 12 to the user of messenger client 2 13 through the messenger server 11, or directly to the messenger function-performing file storage unit 14.

\textcircled{6} The messenger function-performing file storage unit 14 informs the messenger server 11 of the fact that it tries to transfer the file, which is received from the user of messenger client 1 12 through the messenger server 11 or directly, to the user of messenger client 213.

\textcircled{7} The messenger server 11 notifies the user of messenger client 2 13 of the fact that the messenger function-performing file storage unit 14 tries to transfer the file received from the user of messenger client 1 12 and asks the user of messenger client 2 13 whether to receive the file.

\textcircled{8} The user of messenger client 2 13 informs the messenger server 11 of the fact that he or she approves the receipt of the file.

\textcircled{9} The messenger server 11 transfers the IP address of the messenger function-performing file storage unit 14 located in the public Internet network to the user of messenger client 2 13 located in the private Internet network so that the messenger function-performing file storage unit 14 and the user of messenger client 2 13 can exchange the file in a state where they are directly connected to each other.

\textcircled{10} The user of messenger client 2 13 receives the file sent by messenger client 1 12 from the messenger function-performing file storage unit 14 in a state where messenger client 2 13 is connected through the IP address of the messenger function-performing file storage unit 14 informed by the messenger server 14.

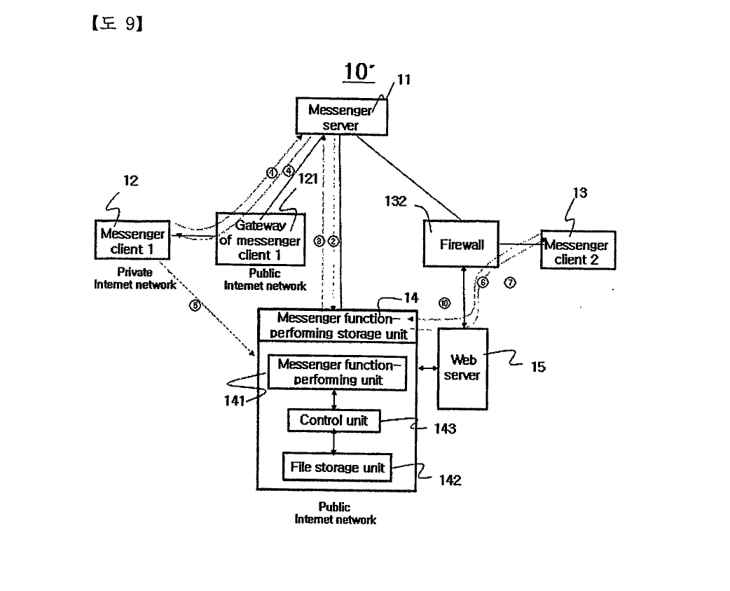

Referring to FIG. 9, a system for storing and transferring the a file using the Internet messenger 10′ according to another embodiment of the present invention includes a messenger server 11, a messenger client 1 12 connected to the messenger server 11 through a private network gateway 121 and located in a private network, a messenger client 2 13 connected to the messenger server 11 through a firewall 132, a messenger function-performing file storage unit 14 connected to the messenger server 11, and a web server 15 serving as a web interface for connecting the firewall 132 and the messenger function-performing file storage unit 14. In the above, messenger client 1 12 can be connected directly to the messenger server 11 through a public Internet network.

In the messenger system 10′ having the firewall installed in messenger client 2 13 according to another embodiment of the present invention, explanation will be given on only portions such as the firewall 132 and the web server 15 except for the same components as those in the messenger system 10 according to an embodiment of the present invention.

The messenger server 11 transfers an IP address of messenger client 2 13 to messenger client 1 12 for the successful transfer of a file. Due to the firewall 132 that is used to prohibit unnecessary external access when the user of messenger client 1 12 accesses messenger client 2 13 or block unnecessary access to external websites from the inside, the file cannot be transferred to the user of messenger client 2 13 or the file of messenger client 2 13 cannot be received.

Therefore, like the messenger system 10 according to an embodiment of the present invention, even though the messenger function-performing file storage unit 14 is connected to the messenger server 11, the file cannot be transferred between the users of the messenger clients due to the firewall 132. However, this can be overcome by additionally connecting the web server 15 to the messenger function-performing file storage unit 14.

In other words, in case where the web server 15 using No. 80 port being a port for common web transmission is connected to the firewall 132 and the messenger function-performing file storage unit 14, access to all websites is impossible if the firewall 132 blocks the port. In this case, the user of messenger client 2 13 may transmit or receive a file through the web server 15 by using the fact that the firewall 132 opens the port.

The file storage unit 142 is a portion that is commonly used by the messenger function-performing file storage unit 14 and the web server 15. If the user of messenger client 1 12 sends a file using the messenger function, the file is stored in the file storage unit 142 through the file storage function of the messenger function-performing file storage unit 14. If the user of messenger client 2 13 transmits the file through a web, the file is stored in the file storage unit 142 through the web server 15.

In the above, the user of messenger client 2 13 inputs the URL (Uniform Resource Locator) of the web server 15, which has been previously received from the messenger function-performing file storage unit 14 through the messenger server 11, to physically access the web server 15, and then clicks on a file region in a web page displayed on a web browser to receive a file that is being stored in the file storage unit 142 or store the file.

The control unit 143 controls the user of messenger client 2 13 to receive the file or store the file through the web server 15.

The process wherein the file is transferred from messenger client 1 12 to messenger client 2 13 in the messenger system 10′ configured as above according to another embodiment of the present invention will now be described. The same portions as the steps (\textcircled{1} to \textcircled{5}) in the messenger system 10 according to an embodiment of the present invention will not be described.

\textcircled{6} The user of messenger client 2 13 accesses the web server 15 by inputting the U RL of the web server 15 received from the messenger function-performing file storage unit 14 through the messenger server 11 using a web browser.

\textcircled{7} The user of messenger client 2 13 receives the file that is being stored in the file storage unit 142 or stores the file by clicking on a file transfer region in a web page displayed on the web browser.

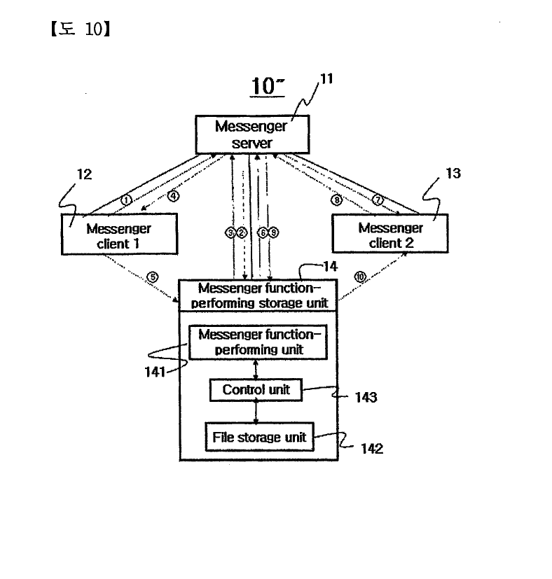

Referring to FIG. 10, a system for storing and transferring a file using an Internet messenger 10″ according to a further embodiment of the present invention includes a messenger server 11, a messenger client 1 12 connected to the messenger server 11, a messenger client 2 13, and a messenger function-performing file storage unit 14 connected to the messenger server 11.

In the above, it is necessarily required that both users of messenger clients 1 12 and 2 13 be in an on-line state for the transfer of a file. If any either of both users is absent, the transfer of the file fails.

Therefore, if the messenger function-performing file storage unit 14 is located in the messenger server 11 to which messenger clients 1 12 and 2 13 are connected, it will appear to the user of each of messenger clients 1 12 and 2 13 that a counterpart user is always on-line in a standby state. It is thus possible to transfer the file.

The process wherein the file is transferred from messenger client 1 12 to messenger client 2 13 in the messenger system 10″ constructed above according to a still further embodiment of the present invention will now be described on the premise that the transfer of the file is impossible because messenger client 2 13 is not in a logged-on or on-line state and the user of messenger client 1 12 thus transfers the file by subscription.

\textcircled{1} The user of messenger client 1 12 informs the messenger server 11 of the fact that he or she will transfer a file to the messenger function-performing file storage unit 14.

\textcircled{2} The messenger server 11 notifies the messenger function-performing file storage unit 14 that always keeps an on-line state of the fact that the user of messenger client 1 12 tries to transfer the file and asks the messenger function-performing file storage unit 14 whether to receive the file.

\textcircled{3} The messenger function-performing file storage unit 14 that always accepts the receipt of a file informs the messenger server 11 of the fact that it will accept the receipt of the file.

\textcircled{4} The messenger server 11 transfers the IP address of the messenger function-performing file storage unit 14 to the user of messenger client 1 12 so that the user of messenger client 1 12 and the messenger function-performing file storage unit 14 can exchange a file in a state where they are directly connected to each other.

\textcircled{5} The user of messenger client 1 12 transfers the file to the messenger function-performing file storage unit 14 in a state where messenger client 1 12 is connected through the IP address of the messenger function-performing file storage unit 14, which is informed by the messenger server 14.

This means that a file that will be sent to the messenger function-performing file storage unit 14 is stored and transmitted by subscription so that the user of messenger client 2 13 can transfer the file whenever the user is in a logged-on or on-line without regard to the state of the user of messenger client 1 12. In this case, the user of messenger client 1 12 also informs indication that a corresponding file is transferred to the user of messenger client 213.

Thereafter, even if the user of messenger client 1 12 is logged off or is in an off-line state, it has no effect on the transfer of the file to the user of messenger client 2 13.

\textcircled{6} The messenger function-performing file storage unit 14 consistently monitors whether the user of messenger client 2 13 is on-line or not. If the user of messenger client 2 13 is newly logged on or achieves an on-line state, the messenger function-performing file storage unit 14 perceives an on-line state from the fact that the on-line state is propagated to a plurality of users having some connection with the user of messenger client 2 13 through the messenger server 11.

The messenger function-performing file storage unit 14 that perceived the on-line state of the user of messenger client 2 13 informs the messenger server 11 of the fact that it will try to transfer the file received from the user of messenger client 1 12 to the user of messenger client 2 13.

\textcircled{7} The messenger server 11 informs the user of messenger client 2 13 of the fact that the messenger function-performing file storage unit 14 tries to transfer the file received from the user of messenger client 1 12 and asks the user of messenger client 2 13 whether to receive the file.

\textcircled{8} The user of messenger client 2 13 notifies the messenger server 11 of the fact that he or she accepts the receipt of the file.

\textcircled{9} The messenger server 11 can transfer the IP address of the messenger function-performing file storage unit 14 to the user of messenger client 2 13 so that the messenger function-performing file storage unit 14 and the user of messenger client 2 13 can exchange the file in a state where they are directly connected to each other, or transfer the IP address of messenger client 2 13 to the user of the messenger function-performing file storage unit 14.

\textcircled{10} The user of messenger client 2 13 receives the file sent by messenger client 1 12 from the messenger function-performing file storage unit 14 in a state where messenger client 2 13 is connected through the IP address of the messenger function-performing file storage unit 14 informed by the messenger server 14.

In the above, the user of messenger client 1 12 does not transfer the file directly, but the file is transferred indirectly through the messenger function-performing file storage un it 14. Thus, there is the uncertainty about whether the file will be transferred correctly. Although the user of messenger client 2 13 is in an on-line state, the state of the user can change to an off-line state due to variation in the state of the user of messenger client 2 13 from an external user such as error in the messenger system. Thus, it is required to monitor whether the file has been transferred correctly. In this case, the messenger function-performing file storage unit 14 can store information on whether the user of messenger client 2 13 has received the file and then transfer the file if the user of messenger client 1 12 wants.

The transfer itself of a file using a conventional messenger is accomplished on the p remise that both users of messenger clients 1 12 and 2 13 are in an on-line state. It is thus impossible to store the file using the messenger. In the system for storing and transferring the file using the Internet messenger 10″ according to a still further embodiment of the pre sent invention, however, a user of any one of messenger clients can store his or her file using a messenger.

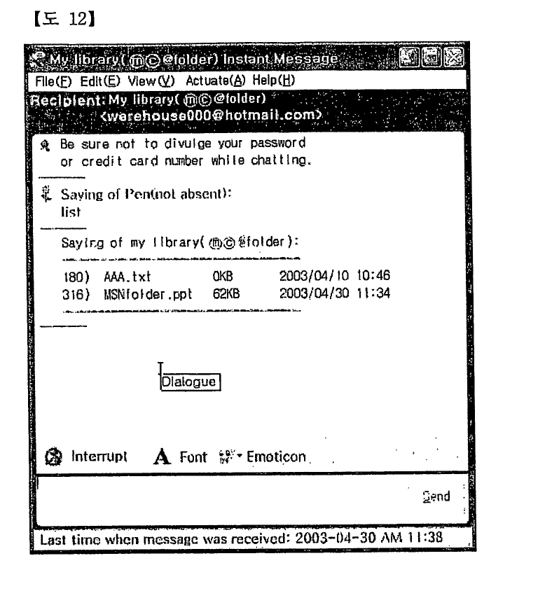

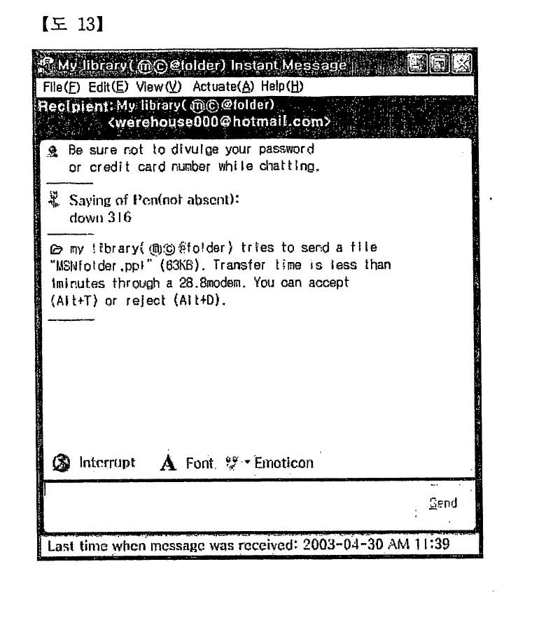

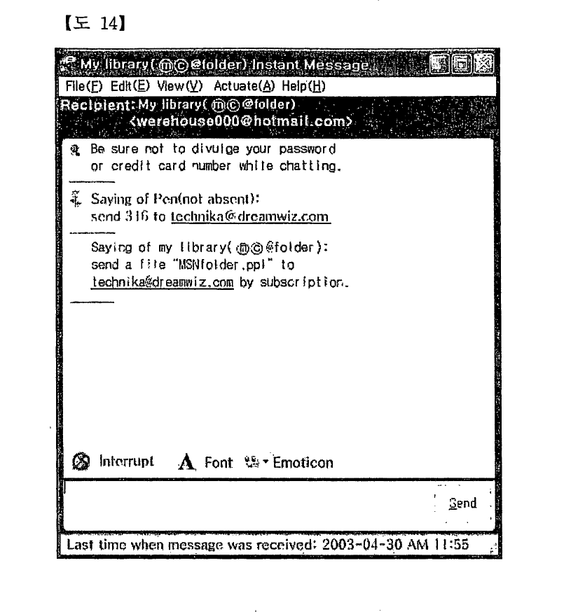

FIGS. 11 to 14 are exemplary screens showing the operating process of the messenger system shown in FIGS. 8 to 10. FIG. 11 is an exemplary screen showing a process of transferring a file to the messenger function-performing file storage unit through the MSN messenger. FIG. 12 is an exemplary screen showing a process of confirming a file stored in the messenger function-performing file storage unit 14. FIG. 13 is an exemplary screen showing a process in which the messenger function-performing file storage unit 14 receives the file through the MSN messenger. FIG. 14 is an exemplary screen showing a process in which a reservation for the transfer of the file is made at the messenger function-performing file storage unit 14 through MSN messenger.

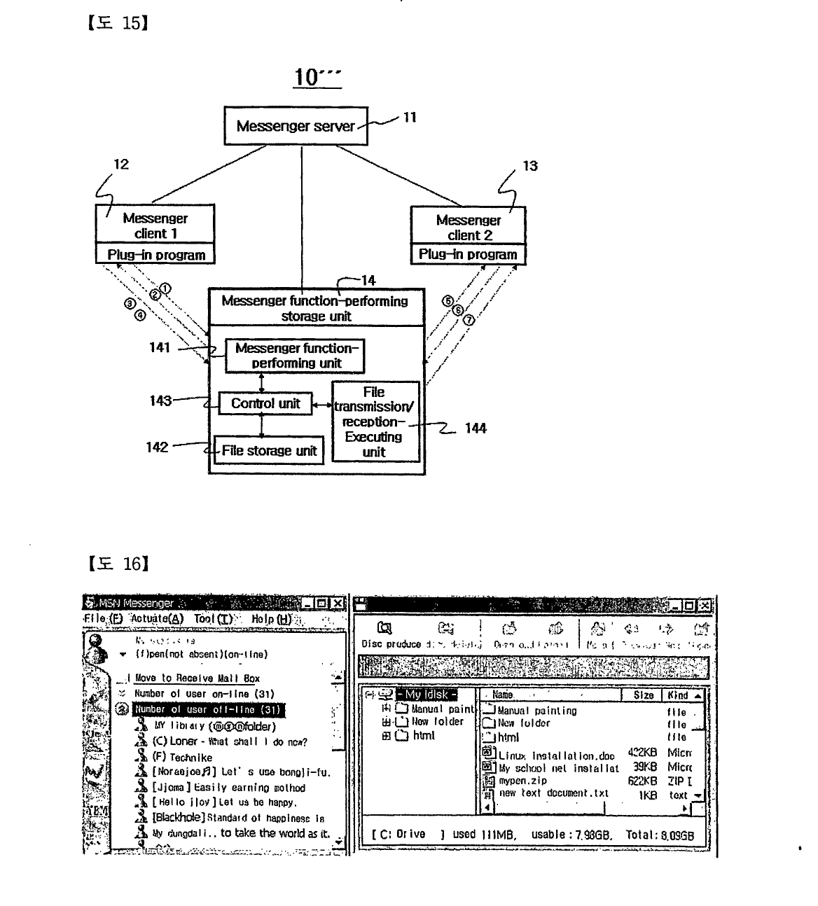

Referring to FIG. 15, a system for storing and transferring files using an Internet messenger 10′″ according to a still further embodiment of the present invention comprises a messenger server 11, a messenger client 1 12 connected to the messenger server 11, messenger client 2 13, and a messenger function-performing file storage unit 14 connected to the messenger server 11.

In the above, messenger clients 1 12 and 2 13 have plug-in programs installed.

In general, the messenger system does not have the following function. That is, when the transfer of a file is interrupted, the file cannot be transferred again from the interrupted point. Furthermore, since a user command of messenger client 1 12 or 2 13, which is transmitted through the messenger server 11, is transmitted in a text-based form, commands for managing a file such as “View File List”, “Transmit File to Other Users” are all composed of characters. It is thus necessary to input corresponding commands one by one.

Therefore, in the event that messenger clients 1 12 and 2 13 have plug-in programs installed and access the messenger function-performing file storage unit 14 through the plug-in programs, the messenger function-performing file storage unit 14 and the plug-in program can exchange a file directly using a unique protocol without intervention of the messenger server 11. As such, the function of successively transmitting a file, which is not supported by the messenger system, can be performed. It is also easy to add a function that is not supported by messenger file transmission.

A file transmission/reception-executing unit 144 of the messenger function-performing file storage unit 14 transmits and receives a file through the plug-in programs installed in messenger clients 1 12 and 2 13.

In other words, if a user of messenger client 1 12 sends a file to the messenger function-performing file storage unit 14, the file is transmitted to the user of messenger client 2 13 separately from the messenger server 11 in a state where messenger client 1 12 is directly connected to the file transmission/reception-executing unit 144 of the messenger function-performing file storage unit 14.

This is because additional transmission of an IP address is not required since the messenger server 11 transfers the IP address between the users of messenger clients 1 12 and 2 13 and a file may thus be transmitted through the plug-in program directly connected to the messenger function-performing file storage unit 14.

In other words, in the above messenger system, the messenger function-performing file storage unit 14 is one of users from the viewpoint of a messenger service. In this structure, however, the messenger function-performing file storage unit 14 becomes an independent server.

Accordingly, the messenger function-performing file storage unit 14 has a function capable of transmitting an additional plug-in program and a file in addition to the transfer of a file through the messenger function. It can be seen that the file transfer function has a dual structure of a file transfer function through the plug-in program and a file transfer function built in the messenger system.

Moreover, in case where messenger clients 1 12 and 2 13 have the plug-in programs installed and access the messenger function-performing file storage unit 14 through the plug-in programs, user commands of messenger clients 1 12 and 2 13 can be transmitted through a graphic interface. Thus, a file administration command is displayed graphically and a command related to the command is also displayed through a mouse not a keyboard or characters. It is thus possible to simplify the user interface.

In the messenger system shown in FIG. 15, the plug-in programs installed in the messenger clients are located on the right side of a messenger window and a personal file window that is being stored in the messenger function-performing file storage unit 14 is displayed in the plug-in program, as shown in FIG. 16.

A difference between a case where a command is issued only through the messenger window without a plug-in program and a case where a command is issued with the plug-in program can be expressed into the following table.

TABLE 1

| Command | Messenger Window | Plug-in |
|---|---|---|
| View File List | “list” | Display from the |
| | | beginning |
| View File List- | Discriminately display | Folder is displayed |
| Folder | folder and file in | hierarchically at |
| | “List” | a glance |
| Upload File | Drag file and transmit | File can be located |
| | it to personal data | within a desired |
| | room user | folder being the same |
| | | plug-in window as the |
| | | messenger window |
| Transmit File to | “Send ## to | Drag and drop file |
| Other Users | email_address” | corresponding to |
| | | plug-in window on the |
| | | user list on the left |
| | | side |
| Delete File | “del” | Select corresponding |
| | | file and then delete |
| | | or throw the file into |
| | | waste basket |
| Administrate | “grouplist”, “groupadd”, | Add or delete user |
| Group | “groupdel” | using mouse |

In the messenger system 10′″ constructed above according to further another embodiment of the present invention, the process of transferring a file from messenger client 1 12 to messenger client 2 13 when plug-in programs are installed in messenger clients 1 12 and 2 13 will now be described on the premise that messenger client 2 13 is in an on-line state.

\textcircled{1} A user of messenger client 1 12 informs the messenger function-performing file storage unit 14 of the fact that he or she wants to transfer a file through the plug-in program.

\textcircled{2} The messenger function-performing file storage unit 14 notifies the plug-in program of messenger client 1 12 of the fact that it accepts the receipt of the file.

\textcircled{2} The plug-in program of messenger client 1 12 completes transferring the file to the messenger function-performing file storage unit 14.

\textcircled{3} The user of messenger client 1 12 informs the messenger function-performing file storage unit 14 of the fact that he or she tries to transfer the file to a user of messenger client 2 13 through the plug-in program.

\textcircled{5} The messenger function-performing file storage unit 14 notifies the user of messenger client 2 13 of the fact that it tries to transfer the file received from the user of messenger client 1 12 to the user of messenger client 2 13 and asks the user of messenger client 2 13 whether to receive the file.

\textcircled{6} The user of messenger client 2 13 informs the messenger function-performing file storage unit 14 of the fact the he or she accepts the receipt of the file through the plug-in program.

\textcircled{7} The user of messenger client 2 13 receive the file from the messenger function-performing file storage unit 14 through the plug-in program.

The plug-in programs installed in messenger clients 1 12 and 2 13 can exchange a file with the messenger function-performing file storage unit 14 that is always connected to messenger clients 1 12 and 2 13 with no help from the messenger server 11. This is because the messenger function-performing file storage unit 14 can analyze a user's command and operate accordingly while serving as a server of the plug-in program.

It is, however, not necessarily required that the plug-in program be installed both in messenger clients 1 12 and 2 13, as shown in FIG. 11. Although a plug-in program for expanding a file transfer function does not exist, the file can be transferred through communication with the messenger server 11 through the messenger function-performing file storage unit 14.

If a plug-in program is installed in messenger client 1 12 only, a process in which messenger client 1 12 transfers a file to the messenger function-performing file storage unit 14 is the same as \textcircled{1} to \textcircled{4}. However, a process in which a file is transferred from the messenger function-performing file storage unit 14 to messenger client 2 13 having the plug-in program not installed in is the same as the process in which the file is transferred from the messenger function-performing file storage unit 14 to messenger client 2 13, which has been described above.

A file storage unit 142 of the messenger function-performing file storage unit 14 ca n operate independently like a storage system provided on the Internet such as POPDESK and WEBHARD. In this case, users can be registered at an additional database as members. Such a database may include a user database for storing detailed information therein su ch as the ID and password of a user who is registered as a member and a file database for storing files sent by users.

### INDUSTRIAL APPLICABILITY

As described above, according to a system and method for storing and transmitting files using an Internet messenger of the present invention, a file can be stored very conveniently without additional log-on or installation of an additional program while using a messenger. Therefore, the present invention has an effect that a corresponding file can be transferred to anyone anywhere and anytime. Further, the Internet messenger serves as a messenger file relay point. According to the present invention, it overcomes a disadvantage of a conventional messenger in which the transfer of a file is impossible or inconvenient due to different user environments.

Although the present invention has been described in connection with the embodiment of the present invention illustrated in the accompanying drawings, it is not limited there to since it will be apparent to those skilled in the art that various substitutions, modifications and changes may be made thereto without departing from the scope and spirit of the invention.

1. A messenger system for storing and transferring a file using an Internet messenger, the messenger system including a messenger server and a plurality of messenger clients connected to the messenger server for exchanging a message or file with the messenger server, comprising:
a messenger function-performing file storage unit connected to the messenger server,
wherein the messenger function-performing file storage unit comprises:
a messenger function-performing unit for receiving a file, which will be transferred from a user of a messenger client serving as a sender to a user of a messenger client serving as a recipient among the plurality of the messenger clients, and transmitting the received file to the user of the messenger client serving as the recipient;
a file storage unit for storing the file received through the messenger function-performing unit therein; and
a control unit for controlling storing the file received through the messenger function-performing unit in the file storage unit and transferring the file stored in the file storage unit to a user of a messenger client serving as a recipient when the user of the messenger client serving as the recipient accepts the receipt of the file.

2. A messenger system for storing and transferring a file using an Internet messenger, the messenger system including a messenger server and a plurality of messenger clients connected to the messenger server for exchanging a message or file with the messenger server, comprising:
a messenger function-performing file storage unit connected to the messenger server,
wherein the messenger function-performing file storage unit comprises:
a messenger function-performing unit for receiving a file that a user of any one of the plurality of the messenger clients wishes to store and transmitting the received file to a user of the messenger client;
a file storage unit for storing the file received through the messenger function-performing unit therein; and
a control unit for controlling storing the file received through the messenger function-performing unit in the file storage unit and transferring the file stored in the file storage unit to a user of the messenger client through the messenger function-performing unit when there is a request from the user of the messenger client.

3. The system as claimed in claim 1, wherein a firewall is installed between the messenger server and the messenger client serving as the sender or between the messenger server and the messenger client serving as the recipient, and
a web interface for connecting the messenger client and the messenger function-performing file storage unit through the firewall is further provided between the firewall and the messenger function-performing file storage unit, whereby the user of the messenger client can receive or store the file that is being stored in the file storage unit using a web browser.

4. The system as claimed in claim 1, wherein the file storage unit is a storage system provided on the Internet.

5. The system as claimed in claim 1, wherein at least one of the plurality of the messenger clients has a plug-in program installed, and
the messenger function-performing file storage unit further comprises a file transmission/reception-executing unit that allows the messenger client having the plug-in program installed in and the messenger function-performing file storage unit to exchange a file directly through the plug-in program.

6. A method for storing/transferring a file in/to a messenger system including a messenger server, a plurality of transmission/reception messenger clients connected to the messenger server for exchanging a message or file with the messenger server, and a messenger function-performing file storage unit connected to the messenger server and having a messenger function and a file storage function, comprising the steps of:
allowing the messenger function-performing file storage unit to receive a file, which is to be transferred from a user of a messenger client serving as a sender to a user of a messenger client serving as a recipient among the plurality of the messenger clients, through the messenger function and then to store the file therein through the file storage function; and
transferring a file stored in the messenger function-performing file storage unit to a user of a messenger client serving as a recipient through the messenger function when the user of the messenger client serving as the recipient accepts the receipt of the file.

7. A method for storing/transferring a file in/to a messenger system including a messenger server, a plurality of transmission/reception messenger clients connected to the messenger server for exchanging a message or file with the messenger server, and a messenger function-performing file storage unit connected to the messenger server and having a messenger function and a file storage function, comprising the steps of:
allowing the messenger function-performing file storage unit to receive a file that will be stored by a user of any one of the plurality of the messenger clients through the messenger function and then to store the file therein through the file storage function; and
transferring a file stored in the messenger function-performing file storage unit to a user of a messenger client through the messenger function when there is a request from the user of the messenger client.

8. The system as claimed in claim 2, wherein the file storage unit is a storage system provided on the Internet.

9. The system as claimed in claim 3, wherein the file storage unit is a storage system provided on the Internet.

10. The system as claimed in claim 2, wherein at least one of the plurality of the messenger clients has a plug-in program installed, and
the messenger function-performing file storage unit further comprises a file transmission/reception-executing unit that allows the messenger client having the plug-in program installed in and the messenger function-performing file storage unit to exchange a file directly through the plug-in program.

11. The system as claimed in claim 3, wherein at least one of the plurality of the messenger clients has a plug-in program installed, and
the messenger function-performing file storage unit further comprises a file transmission/reception-executing unit that allows the messenger client having the plug-in program installed in and the messenger function-performing file storage unit to exchange a file directly through the plug-in program.
